(19) United States
(12) Patent Application Publication
(10) Pub. No.: US 2019/0121167 A1
(43) Pub. Date: Apr. 25, 2019

(54) CLIP-ON GLASSES WITH REPLACEABLE LENS

(71) Applicant: Interstol Trading Co. Inc., Seattle, WA (US)

(72) Inventor: Anthony Suen, Hong Kong (CN)

(21) Appl. No.: 15/789,883

(22) Filed: Oct. 20, 2017

(51) Int. Cl. G02C 9/04; G02C 5/06

(52) U.S. Cl. CPC G02C 9/04; G02C 2200/08; G02C 5/06

(57) ABSTRACT

A clip-on assembly for attaching to an eye glass frame is described herein. The clip-on assembly may be designed to permit easy removal/replacement of one or more lenses from the clip-on assembly. The clip-on assembly may include at least one lens and a frame assembly. The at least one lens having pairs of lens mortises or notches located along outer portions of the at least one lens. The frame assembly may include at least one rim designed to receive the at least one lens, the rim including a pair of lens tenon members, each lens tenon member includes a pair of lens tenon legs that are each designed to fit into corresponding lens mortises of the at least one lens.

### BACKGROUND

### 1. Field of the Invention

The present invention relates to optical accessories, and more particularly to clip-on assembly configured to attach onto spectacles.

### 2. Description of Related Art

It is well-recognized that the visual or optical needs of a person will vary greatly from person to person depending upon various factors including the age of the person, the specific ophthalmic needs of the person, the occasion or setting, and so forth. For example, a person may have multiple prescription glasses including one for driving, one for reading, and one for viewing screens of computer monitors. In addition, the person may maintain one or more sunglasses for various situations such as for driving, walking, playing sports, etc. In some situations, a person will concurrently need both the functionalities of corrective lens of prescription glasses, and the filtering functionalities of sunglasses. At other times, the person may only need the functionalities of only one type of glasses (e.g., corrective lens). To address these situations, various optical solutions have been developed over the years including tinted or light sensitive prescription glasses, flip-up sunglasses, and clip-on sunglasses.

Clip-on sunglasses or simply “clip-ons” have been widely available for many years. Conventional clip-ons typically include a frame with tinted lens disposed within the frame. These clip-ons will be without temples, and instead have components such as grapnels on the frame that are designed to clip and mount onto the frame or lenses of primary glasses such as prescription glasses.

Although clip-ons have proven to be an inexpensive solution to the multiple needs of eye glass wearers, they have proven to be somewhat limited as the lenses disposed within the frame of the clip-ons are usually fixed into the frame of the clip-on and are not easily replaceable. For example, if a user has different filtering needs for different occasions (e.g., filtering needs related to driving, filtering needs related to casual outdoor activities, and so forth), then the user would need to use multiple clip-ons for each occasion,

### SUMMARY

Various embodiments of the present disclosure provide for a clip-on lens assembly that is configured to attach to an eye glass frame. For these embodiments, the clip-on assembly may include at least one lens and a frame assembly. The at least one lens may have an outer edge portion along the perimeter of the lens and a first pair of lens mortises (e.g., notches) disposed at a first portion of the outer edge portion and a second pair of lens mortises disposed at a second portion of the outer edge portion located opposite of the first portion.

In some cases, the frame assembly may include at least one rim that is configured for receiving the at least one lens, the at least one rim having at least two lens tenon members, each of the at least two lens tenon members including a pair of lens tenon legs that are linked together by a lateral bar. Each of the pair of lens tenon legs of each lens tenon member may be further coupled to the at least one rim and may extend away from the at least one rim in a direction having a component perpendicular to a fitted plane defined by the at least one rim. Each of the lens tenon legs may be fixedly disposed relative to the at least one rim such that when the at least one lens is received by the at least one rim in releasably coupled fashion, each of the lens tenon legs may align into a corresponding lens mortise of the first pair of lens mortises or a corresponding lens mortise of the second pair of lens mortises of the at least one lens.

In some embodiments, the at least one lens may have a concave (e.g., concave from a wearer's perspective) shape and may be made of a resilient flexible material. In some cases, when the at least one lens is received by the at least one rim in releasably coupled fashion, a section of the outer edge portion of the at least one lens is aligned inward of the lateral bar such that the lateral bar covers the section of the outer edge portion as viewed from a front of the clip-on lens assembly. In some embodiments, the at least two lens tenon members and the a least one rim of the frame assembly may be formed from a continuous non-resilient band such as a continuous metallic band. In some cases, the lens tenon legs of the at least two lens tenon members may be formed by bending four locations of the continuous non-resilient band. In some embodiments, the at least one rim may include one or more grapnels.

In various embodiments, a lens frame assembly is disclosed herein. The lens frame assembly may include a bridge component and a pair of looped rims that are coupled to opposing end portions of the bridge component, each of the pair of looped rims having a pair of opposing rim members. For these embodiments, a looped rim may further include at least two lens tenon members, each of the two lens tenon members linking together a pair of end portions of the pair of opposing rim members of the looped rim. Each of the at least two lens tenon members may include a pair of lens tenon legs and a lateral bar linking the pair of lens tenon legs. The pair of lens tenon legs may extend away from a fitted plane of the lopped rim in a direction that includes a component perpendicular to the fitted plane. The pair of lens tenon legs may be spaced apart to align with corresponding spaced apart lens mortises on a corresponding lens to be received by the looped rim.

### BRIEF DESCRIPTION OF THE DRAWINGS

FIG. 1 is an exploded perspective view of a clip-on lens assembly.

FIG. 2 is a close-up view of a portion of a lens illustrated in FIG. 1.

FIG. 3A is an elevated perspective view of a lens tenon member illustrated in FIGS. 1 and 2.

FIG. 3B is a side view of the lens tenon member illustrated in FIG. 3A.

FIG. 4A is a front view of a frame assembly illustrated in FIG. 1.

FIG. 4B is a front view of lenses illustrated in FIG. 1.

### DETAILED DESCRIPTION

In the present description, certain specific details are set forth in order to provide a thorough understanding of various embodiments of the disclosure. However, upon reviewing this disclosure one skilled in the art will understand that the various embodiments disclosed herein may be practiced without many of these details. In other instances, some well-known structures and materials of construction have not been described in detail to avoid unnecessarily obscuring the descriptions of the embodiments of the disclosure.

In the present disclosure, to the extent the terms “about,” “approximately,” and “substantially” are used, they mean±20% of the indicated range, value, or structure, unless otherwise indicated. In the present description, the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, the terms and variants of which are intended to be construed as non-limiting. The definitions in this paragraph are intended to apply throughout this disclosure unless otherwise expressly stated.

According to various embodiments of the present disclosure, a clip-on lens assembly is disclosed that may include one or more replaceable lenses and a frame assembly that is configured to receive the one or more replaceable lenses and that can be clipped/mounted onto an eyeglass frame (e.g., prescription or non-prescription glasses with corrective or non-corrective lens). For these embodiments, the frame assembly may include features that permit an end user to easily insert, remove, or replace the one or more replaceable lenses from the frame assembly with one or more other replaceable lenses. In some embodiments, each of the replaceable lenses (hereinafter simply “lenses”) may include features that may permit them to be easily mated with, as well as to remove from, the frame assembly as will be further described herein.

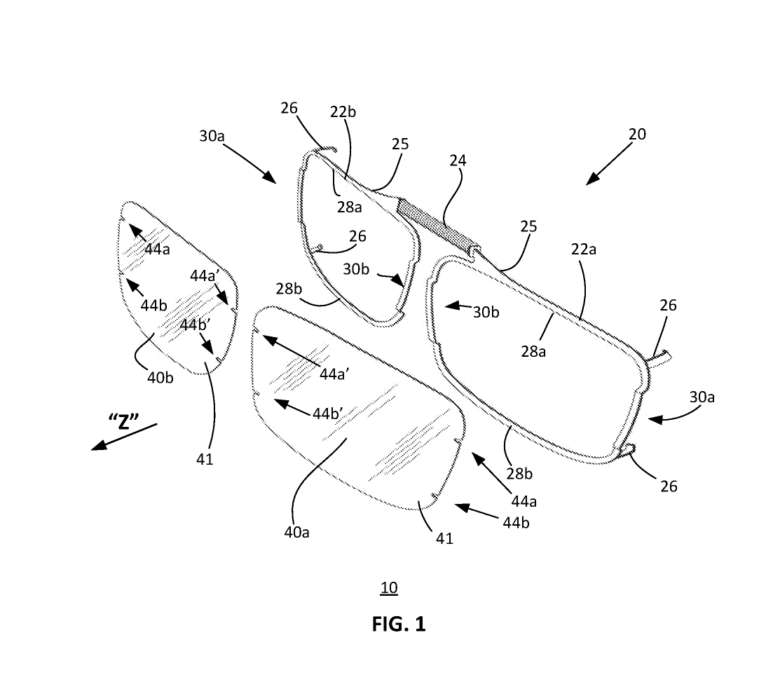

FIG. 1 is an exploded perspective view of an example clip-on lens assembly 10 according to various embodiments. As illustrated, the example clip-on lens assembly 10 includes a frame assembly 20 and a pair of lenses 40a and 40b. The frame assembly 20 may include a pair of rims 22a and 22b that may be coupled to opposing end portions of a bridge component 24. In some embodiments, the bridge component 24 may be an expandable spring-loaded bridge member.

Each rim 22a and 22b may include a pair of opposing rim members 28a and 28b that may be coupled or bridged together by a pair of lens tenon members 30a and 30b. In some cases, the opposing end portions 25 of the bridge component 24 may be coupled to opposing rim members 28a of rims 22a and 22b. In some embodiments, lens tenon members 30a and 30b may substantially mirror each other. As will be further described herein, lens tenon members 30a and 30b may be configured to ensure that corresponding lenses 40a and 40b may be securely attached to the rims 22a and 22b.

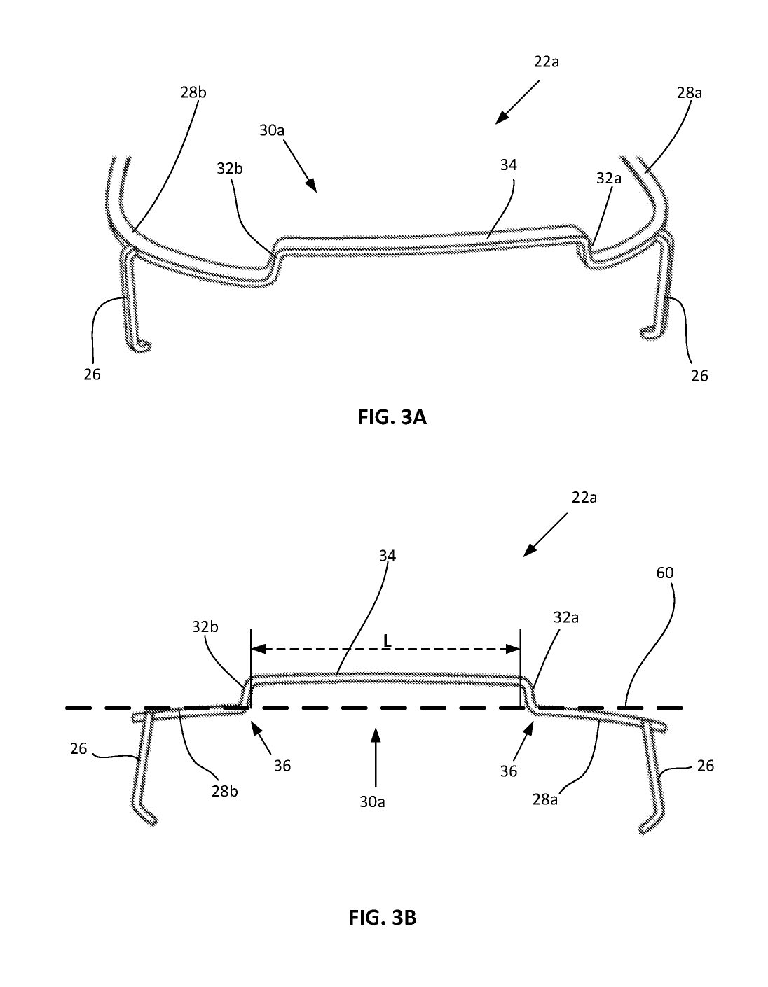

FIG. 3A is an elevated perspective view of a lens tenon member 30a of rim 22a. In some cases, each of the lens tenon members 30a and 30b of each rim 22a and 22b may have the same or similar “handle bar” shape and may include the same or similar features as those described herein with respect to lens tenon member 30a of rim 22a. Also, in various embodiments, rim 22b may substantially mirror rim 22a having the same or similar features as rim 22a (e.g., opposing rim members 28a and 28b coupled together by a pair of lens tenon members 30a and 30b). Note that in the following, “*” represents a wildcard. Thus, references in the following description to, for example, “rim 22*” may be in reference to rim 22a or rim 22b.

Each of the lens tenon members 30* of rims 22* may include a pair of lens tenon legs 32a and 32b that are coupled together via a lateral bar 34 (see FIGS. 3A and 3B) and that are coupled to ends 36 (see FIG. 3B) of the pair of opposing rim members 28*. Attached to each rim 22* may be one or more grapnels 26 that are designed to clamp or hook to an eye glass frame. Note that although each of the lens tenon members 30* is described herein as having the same or similar features (e.g., a pair of lens tenon legs 32* that are coupled together via a lateral bar 34), the specific dimensions of these features may vary between the different lens tenon members 30* of frame assembly 20.

Each lens 40a and 40b may include two pairs of lens mortises 44* (e.g., lens mortises pair 44a and 44b, and lens mortises pair 44a′ and 4b′) that are disposed at the outer edge portions 41 (e.g., perimeter portions) of lenses 40a and 40b. In various embodiments, the lens mortises 44* may be notches that are located along the perimeter or outer edge portions 41 of their respective lens 40a and 40b. Each of the lens mortises 44* may be configured to receive corresponding lens tenon legs 32* of the frame assembly 20 when the lens 40a and 40b are inserted between the lens tenon members 30* of rims 22a and 22b.

Note that in the following description, words such as “front,” “forward,” “inwards,” “rearwards,” and the like are used herein to refer to the direction in which a user wears and looks through the clip-on lens assembly 10. For example, the user's line of sight will generally parallel direction “Z” as illustrated in FIG. 1. For ease of illustration and explanation, the following description of the clip-on lens assembly 10 may be provided with respect to lens 40a and rim 22a. However, and as one of ordinary skill in the art will recognize, the various features/aspects of lens 40a and rim 22a to be described herein may be equally applicable to lens 40b and rim 22b unless indicated otherwise. Further, although the clip-on lens assembly 10 is described and illustrated herein as having a frame assembly 20 with a pair of rims 22a and 22b, and a pair of lenses 40a and 40b, as one of ordinary skill in the relevant art will recognize, the clip-on lens assembly 10 may include a frame assembly 20 with only a single rim 22*, and a single lens 40* in alternative embodiments.

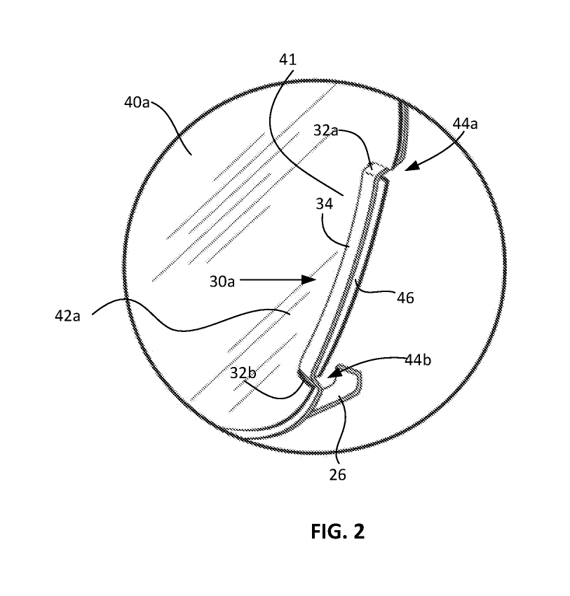

Turning to FIG. 2, which is a close-up view of a first portion 42a of an outer edge portion 41 of lens 40a of FIG. 1 after lens 40a has been fitted between two lens tenon members 30a and 30b of rim 22a of the frame assembly 20. In some embodiments, each of the lens tenon member 30a and 30b of rim 22a includes a pair of lens tenon legs 32a and 32b that are coupled together via a lateral bar 34 (see also FIGS. 3A and 3B), each of the two lens tenon legs 32* being further coupled to ends 36 (see FIG. 3B) of respective opposing rim members 28* of the rim 22a. The outer edge portion 41 may be the peripheral or perimeter portion or portions of lens 40a.

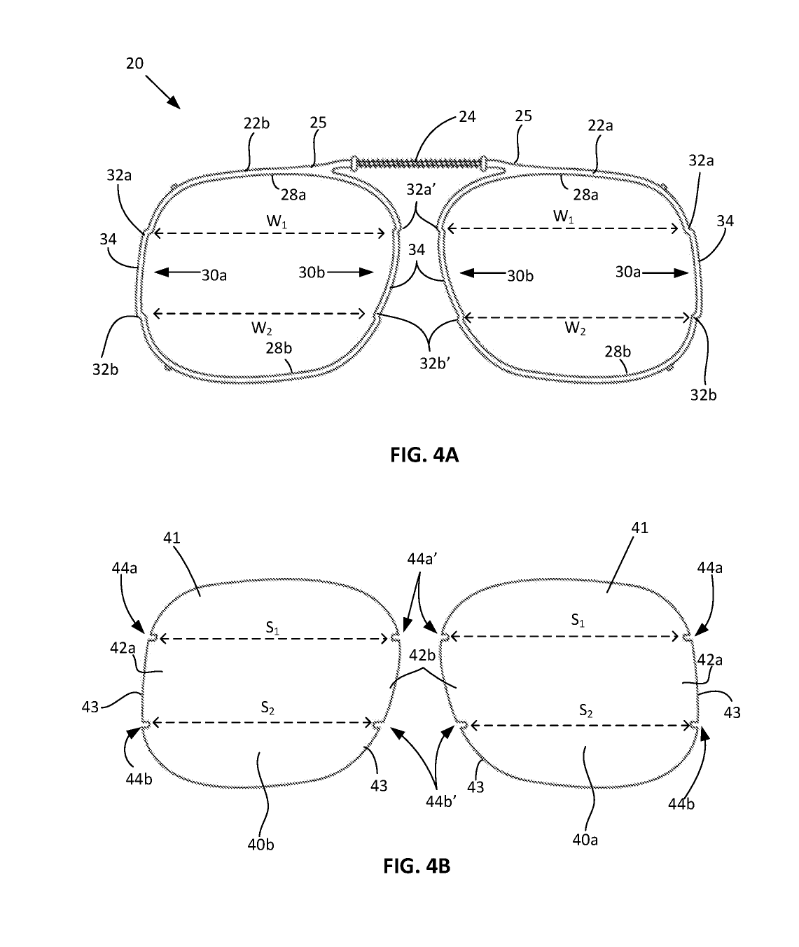

When lens 40a has been inserted between the two lens tenon members 30a and 30b of rim 22a, a section 46 of a first portion 42a of the outer edge portion 41 of lens 40a may be aligned inward of the lateral bar 34 of the lens tenon member 30a of rim 22a such that the lateral bar 34 covers section 46 of the first portion 42a of the outer edge portion 41 of lens 40a as viewed from the front of the clip-on lens assembly 10. As illustrated, section 46 is between lens mortises 44a and 44b. When lens 40a has been mated with rim 22a by being inserted between the two lens tenon members 30a and 30b of rim 22a, the lens tenon legs 32* (see lens tenon legs 32a, 32b, 32a′, and 32b′ of FIG. 4A) of rim 22a will be seated/disposed within corresponding lens mortises 44* (see lens mortises 44a, 44b, 44a′, and 44b′ of FIG. 4B) of lens 40a. As a result, when lens 40a has been mated with rim 22a, as well as when lens 40b has been mated with rim 22b, the lens tenon legs 32* of rims 22a and 22b may be disposed laterally inward of an outer edge perimeter of lenses 40a and 40b.

FIG. 3A is an elevated perspective view of lens tenon member 30a of rim 22a of FIGS. 1 and 2. FIG. 3B is the side view of the lens tenon member 30a illustrated in FIG. 3A. It should be noted that the following description of various features of lens tenon member 30a of rim 22a may be equally applicable to the other lens tenon members 30* of rims 22a and 22b in various embodiments. In some embodiments, the rim 22a, which includes a pair of opposing rim members 28a and 28b that are linked together via a pair of lens tenon members 30a and 30b (one of which is shown in FIGS. 3A and 3B), may define a fitted plane 60 (see FIG. 3B, which shows the cross-sectional view of the fitted plane 60).

Each lens tenon member 30* of rim 22a, as well as rim 22b, may include a pair of lens tenon legs 32*. For example, lens tenon member 30a as illustrated in FIGS. 3A and 3B includes lens tenon legs 32a and 32b that are coupled or bridged together by a lateral bar 34. Each of the lens tenon legs 32* of lens tenon member 30a may extend away from the fitted plane 60 of rim 22a. As illustrated in FIG. 3B, the ends of lens tenon legs 32* that are opposite from the ends of the lens tenon legs 32* that are coupled to the lateral bar 34 may be coupled to ends 36 of the opposing rim members 28a and 28b.

Each of the lens tenon legs 32* of lens tenon member 30a may extend away from the fitted plane 60 in a direction that includes a component perpendicular to the fitted plane 60. That is, although each of the lens tenon legs 32* of lens tenon member 30a may not extend away from the fitted plane 60 in a perfectly perpendicular direction relative to the fitted plane 60 in some embodiments as illustrated in FIGS. 3A and 3B, they do extend away from the fitted plane 60 in a substantially perpendicular direction from the fitted plane 60. For example, in some embodiments, each of the lens tenon legs 32* of lens tenon member 30a may extend away from the fitted lane 60 at an angle greater than 45 degrees. In some alternative embodiments, however, the lens tenon legs 32 may extend away from the fitted plane 60 in a perpendicular direction relative to the fitted plane 60.

In some embodiments, the lateral bar 34 of lens tenon member 30a of rim 22a (as well as the other lens tenon members 30* of rims 22a and 22b) may have a length (L) that is greater than 10 millimeters (mm). That is, the length of lateral bar 34 may define how far apart the pair of lens tenon legs 32a and 32b are spaced apart. If the pair of lens tenon legs 32a and 32b, along with the other pair of lens tenon legs 32a′ and 32b′ of rim 22a (see FIG. 4A), are spaced too close together, the corresponding lens 40a with lens mortises 44 (e.g., lens mortises 44a, 44b, 44a′, and 44b′—see FIG. 4B) that are configured to receive the lens tenon legs 32* may not be stably and securely attached to rim 22a. By sufficiently spacing apart the pairs of lens tenon legs 32* (e.g., pair of lens tenon legs 32a and 32b, and pair of lens tenon legs 32a′ and 32b′ of FIG. 4A) of, for example, rim 22a, lens 40a may be well-secured to rim 22a. For example, in one implementation, the pairs of lens tenon legs 32* (e.g., pair of lens tenon legs 32a and 32b, and pair of lens tenon legs 32a′ and 32b′ of FIG. 4A) may be spaced apart by approximately 18 mm. In alternative implementations, however, the pairs of lens tenon legs 32* may be spaced apart by a greater or smaller distance.

FIG. 4A is a front view of the frame assembly 20 of FIG. 1. As illustrated, the frame assembly 20 includes a pair of rims 22a and 22b attached to opposing end portions 25 of a bridge component 24. In various embodiments, the two rims 22a and 22b may be mirror images of each other having the same or similar components/features. For example, each of the rims 22a and 22b may include opposing lens tenon members 30a and 30b that are coupled or linked together via a pair of opposing rim members 28a and 28b. Each of the opposing lens tenon members 30a and 30b includes a pair of lens tenon legs 32* coupled by a lateral bar 34. For example, lens tenon member 30a includes lens tenon legs 32a and 32b coupled by a lateral bar 34, while lens tenon member 30b includes lens tenon legs 32a′ and 32b′.

In various embodiments, rims 22a and 22b may be made from non-resilient material such as, for example, stainless steel or other non-resilient material. In some cases, each of the rims 22a and 22b may be a looped rim that may be formed from a continuous non-resilient band. In embodiments where the rims 22a and 22b are made from a non-resilient but malleable material such as a metal or a metal alloy, the lens tenon members 30a and 30b may be formed by bending selected portions of rims 22a and 22b, or by other means known in the relevant art.

FIG. 4B is a front view of lens 40a and 40b of FIG. 1. In various embodiments, lens 40a and 40b may be mirror image of each other having the same or similar features. For example, each lens 40a or 40b may include lens mortises 44* that are located laterally inward and within the outer edge perimeter 43 of the respective lens 40a and 40b. For example, a pair of lens mortises 44a and 44b may be located at a first portion 42a of an outer edge portion 41 of lens 40a or 40b, and a pair of lens mortises 44a′ and 44b′ may be located at a second portion 42b of the outer edge portion 41 of lens 40a or 40b. In some embodiments, the distances between the lens mortises 44* of each pair of lens mortises 44* (e.g., distance between lens mortises 44a and 44b and distance between lens mortises 44a′ and 44b′) may be at least 10 mm. For example, in one implementation, the distance between each pair of lens mortises 44* is approximately 18 mm. When lens 40a and 40b are inserted between the lens tenon members 30* of corresponding rims 22a and 22b, each of the lens tenon legs 32* of rims 22a and 22b may be disposed within the lens mortises 44* of lenses 44a and 44b and laterally inward of the outer edge perimeter 43 of lenses 44a and 44b.

In some embodiments, each of the lens 40a and 40b may have a concave shape (e.g., concave shape from the perspective of a wearer) and may be made from a flexible resilient material including any one or more of a variety of plastics such as polycarbonate (PC), cellulose acetate butyrate (CAB), Triacetate Cellulose (TAC), and so forth. When lens 40a and 40b are inserted between the lens tenon members 30a and 30b of their corresponding rims 22a and 22b, the lens tenon legs 32* (e.g., lens tenon legs 32a, 32b, 32a′, and 32b′) of each rim 22a and 22b may be aligned or seated into the lens mortises (e.g., lens mortises 44a, 44b, 44a′, and 44b′) of corresponding lenses 40a and 40b.

In various embodiments, the specific features of lens 40a and 40b and rims 22a and 22b, such as the lens mortises 44* of lenses 40a and 40b and the lens tenon legs 32* of rims 22a and 22b, may be particularly configured/oriented to ensure that lenses 40a and 40b will be secured to corresponding rims 22a and 22b. For example, and as illustrated in FIG. 4A, in various embodiments, lens tenon leg 32a may be separated from lens tenon leg 32a′ of rim 22a or 22b by distance W₁, while lens tenon leg 32b may be separated from lens tenon leg 32b′ of rim 22a or 22b by distance W₂. Meanwhile, lens mortise 44a may be separated from lens mortise 44a′ of lens 40a or 40b by distance S₁, while lens mortise 44b may be separated from lens mortise 44b′ of lens 40a or 40b by distance S₂. In various embodiments, to ensure that lens 40a and 40b will be secured to rims 22a and 22b when the lenses 40a and 40b are inserted between lens tenon members 30a and 30b of rims 22a and 22b, S₁ may be greater than W₁ and S₂ may be greater than W₂. That is, to ensure that lenses 40a and 40b are securely mated with rims 22a and 22b, S₁>W₁ and S₂>W₂ when lenses 40a and 40b are in their natural uncompressed states. By leveraging the wider widths of lenses 40a and 40b with respect to the widths of the corresponding rims 22a and 22b, and leveraging the resilient characteristic, and in some cases the concave shape, of lens 40a and lens 40b, lenses 40a and 40b may be safely secured to corresponding rims 22a and 22b.

The various embodiments described herein, are presented as non-limiting example embodiments of the present disclosure, unless otherwise expressly indicated. After reviewing the present disclosure, an individual of ordinary skill in the art will immediately appreciate that some details and features can be added, removed and/or changed without deviating from the spirit of the disclosure. Reference throughout this specification to “various embodiments,” “one embodiment,” “an embodiment,” “additional embodiment(s)”, “alternative embodiments,” or “some embodiments,” means that a particular feature, structure or characteristic described in connection with the embodiment(s) is included in at least one or some embodiment(s), but not necessarily all embodiments, such that the references do not necessarily refer to the same embodiment (s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification, but should be construed to include all possible embodiments along with the full scope of equivalents to which such claims are entitled. Accordingly, the claims are not limited by the disclosure.

What is claimed is:

1. A clip-on lens assembly configured for attachment to an eye glass frame, comprising:
at least one lens having an outer edge portion and a first pair of lens mortises disposed at a first portion of the outer edge portion and a second pair of lens mortises disposed at a second portion of the outer edge portion opposite of the first portion; and
a frame assembly including at least one rim configured for receiving the at least one lens, the at least one rim having at least two lens tenon members, each of the at least two lens tenon members including a pair of lens tenon legs that are linked together by a lateral bar, the pair of lens tenon legs each being further coupled to the at least one rim and extending away from the at least one rim in a direction having a component perpendicular to a fitted plane defined by the at least one rim, each of the lens tenon legs being fixedly disposed relative to the at least one rim such that when the at least one lens is received by the at least one rim in releasably coupled fashion, each of the lens tenon legs aligns into a corresponding lens mortise of the first pair of lens mortises or a corresponding lens mortise of the second pair of lens mortises.

2. The clip-on lens assembly of claim 1, wherein when the at least one lens is received by the at least one rim in releasably coupled fashion, each of the lens tenon legs is disposed laterally inward of an outer edge perimeter of the at least one lens.

3. The clip-on lens assembly of claim 2, wherein the first pair of lens mortises disposed at the first portion are spaced apart in the first portion by a distance of at least 10 millimeters (mm).

4. The clip-on lens assembly of claim 3 wherein the second pair of lens mortises disposed at the second portion are spaced apart in the second portion by a distance of at least 10 mm.

5. The clip-on lens assembly of claim 1, wherein the at least one lens has a concave shape and is made of a resilient flexible material.

6. The clip-on lens assembly of claim 1 wherein when the at least one lens is received by the at least one rim in releasably coupled fashion, a section of the outer edge portion of the at least one lens is aligned inward of the lateral bar such that the lateral bar covers the section of the outer edge portion as viewed from a front of the clip-on lens assembly.

7. The clip-on lens assembly of claim 1, wherein the lateral bars of each of the lens tenon members are at least 10 millimeters (mm) long.

8. The clip-on lens assembly of claim 1, wherein the at least two lens tenon members and the at least one rim are formed from a continuous non-resilient band.

9. The clip-on lens assembly of claim 8, wherein the continuous non-resilient band is a continuous metallic band.

10. The clip-on lens assembly of claim 8, wherein the lens tenon legs of the at least two lens tenon members are formed by bending four locations of the continuous non-resilient band.

11. The clip-on lens assembly of claim 1, wherein at least one grapnel is attached to the at least one rim.

12. A lens frame assembly comprising:
a bridge component;
a pair of looped rims coupled to opposing end portions of the bridge component, each of the pair of looped rims having a pair of opposing rim members; and
at least two lens tenon members for each of the pair of looped rims, each of the two lens tenon members linking together a pair of end portions of the pair of opposing rim members of one of the pair of looped rims, the at least two lens tenon members each including a pair of lens tenon legs and a lateral bar linking the pair of lens tenon legs, the pair of lens tenon legs each extending away from a fitted plane of one of the pair of lopped rims in a direction that includes a component perpendicular to the fitted plane, the pair of lens tenon legs being spaced apart to align with corresponding spaced apart lens mortises on a corresponding lens to be received by at least one of the pair of looped rims.

13. The frame assembly of claim 12, wherein the opposing end portions of the bridge component are attached to opposing rim members of the pair of looped rims.

14. The frame assembly of claim 12 wherein the lateral bars of each of the lens tenon members are at least 10 millimeters (mm) long.

15. The frame assembly of claim 12, wherein each of the looped rims compromises a continuous non-resilient band.

16. The frame assembly of claim 15, wherein the continuous non-resilient bands of each of the looped rims is a continuous metallic band.

17. The frame assembly of claim 15, wherein the lens tenon legs of the looped rims formed by bending four locations of each of the continuous non-resilient bands that comprises the looped rims.

18. The frame assembly of claim 12, wherein at least one grapnel is attached to each of the looped rims.

19. The frame assembly of claim 12, wherein the bridge component is an expandable spring bridge mechanism.
